(19) United States
(12) Patent Application Publication
(10) Pub. No.: US 2022/0322846 A1
(43) Pub. Date: Oct. 13, 2022

(54) ROCKING MECHANISM AND A CRIB WITH A ROCKING MECHANISM

(71) Applicants: Dezhu Ou, Heyuan (CN); Hudang Wang, Hunan Province (CN)

(72) Inventors: Dezhu Ou, Heyuan (CN); Hudang Wang, Hunan Province (CN)

(21) Appl. No.: 17/542,878

(22) Filed: Dec. 6, 2021

(30) Foreign Application Priority Data
Apr. 7, 2021 (CN) 202110372011.2

(51) Int. Cl. A47D 9/02

(52) U.S. Cl. CPC A47D 9/02

(57) ABSTRACT

The present invention relates to a crib, and discloses a rocking mechanism and a crib with a rocking mechanism, which includes a fixed seat (2) for mounting support legs (1) and a movable seat (3) for mounting a cradle, and a connection mechanism (4) is provided between the fixed seat (2) and the movable seat (3), and the connection mechanism (4) includes at least two connection rods (401) set side by side, and the movable seat (3) and the fixed seat (2) are provided with the connection holes (301) to house both ends of the connecting rod (401), and the connection holes (301) are provided with bearings (402) installed on the connecting rod (401). The invention allows a gentler way to rock multiple cribs, which lowers the risk of hurting infants, and promises simple structure, low cost and ease of use.

### CROSS-REFERENCE TO RELATED APPLICATIONS

This application claims priority to Chinese Patent Application 202110372011.2, filed on Apr. 7, 2021, which is incorporated herein by reference.

### FIELD OF THE INVENTION

The present invention relates to a crib, and in particular to a crib with a rocking mechanism.

### BACKGROUND

A crib is a sleeping bed for infants, and is being improved with developing technology to meet higher demands in this regard, such as the need for the crib to have a rocking function so that infants can sleep better, but the existing cribs are generally rocked in a way that makes the crib tilt back and forth, which is likely to hurt the infants, and comes with complicated structure and high cost, besides, it's not easy to use.

### BRIEF SUMMARY OF THE INVENTION

The present invention discloses a rocking mechanism and a type of crib with a rocking mechanism to address the issues of existing cribs.

The present invention provides the following technical solution to address the issues mentioned above:

Significant results have been achieved with the technical solution adopted by the present invention:

The rocking mechanism includes a fixed seat for mounting support legs and a movable seat for mounting the cradle. A connection mechanism is provided between the fixed seat and the movable seat. The connection mechanism includes at least two connecting rods set side by side. The movable seat and the fixed seat are provided with connecting holes to house both ends of the connecting rods, and the connecting holes are provided with bearings snapped onto the connecting rods.

Preferably, the inner wall of the connecting hole is provided with a bearing mount for installing the bearing.

Preferably, the bearing mount includes several long strips arranged along the length of the connecting hole, the said long strips are evenly arranged around the axis of the connecting hole, and the upper and lower ends of the long strips are constructed together with the inner walls of the two ends of the connecting hole to form two bearing mounting positions for installing the bearing. The bearing mount has a simple structure and is produced into one piece with the connection hole, which saves cost and increases the structural strength of the connection hole.

Preferably, the connecting rod includes two vertical rods and one horizontal rod, the vertical rod is inserted into the connecting hole, and the upper and lower ends of the vertical rod are provided with bearings. The upper end of the vertical rod is provided with external threads and has a limit nut against the upper surface of the bearings; and the outer wall of the lower end of the vertical rod is provided with a limit protrusion for axially limiting the lower bearing. The connecting rod is so structured to ensure that the movable seat and the fixed seat are well connected without compromising the rocking function of movable seat.

Preferably, it also includes a limiting mechanism which comprises a limit slot on the fixed seat, a limit block on the movable seat and to be inserted into the limit slot, as well as a pull rod connected to the limit block to drive the limit block into or out of the limit slot and a toggle for driving the pull rod, with the pull rod being attached to the limit block at one end and connected to the toggle at the other end. The limiting mechanism is so structured to ensure the stability of the rocking crib and promise an easy-to-use experience.

Preferably, the movable seat is provided with a sliding seat which is provided with a longitudinally extended sliding slot. The limit block is set in the sliding slot and can slide up and down along the inner wall of the sliding slot. The side wall of the sliding seat is provided with a longitudinally extended long slot for the pull rod to pass through. The sliding seat is so structured to ensure the stability and straightness of the upward and downward movement of the limit block, allowing the pull rod to pull or push the limit block.

Preferably, the side wall of the limit block is provided with a connection slot for the pull rod to pass through, and the upper inner wall of the connection slot is provided with a downwardly curved protrusion. The end of the pull rod connected to the limit block is bent downward to form an inclined rod section that matches the curved protrusion, and the end of the inclined rod section is bent horizontally to form a horizontal rod end. The end of the pull rod is so structured that the pulling or pushing force sent by the inclined rod section is applied to the limit block for effectively moving it up or down with the pull rod, so that movable seat can be fixed on or freed from the fixed seat.

Preferably, the movable seat is provided with anti-collision strips on the two outer walls along the movable direction. The anti-collision strips are provided as the shock absorber between the movable seat and the fixed seat in the rocking process, which can effectively absorb the shock and reduce noise.

Preferably, the upper surface of the movable seat is provided with a slot, the bottom surface of the slot is provided with the fixed hole; the slot mechanism is set to ensure the higher stability of the cradle frame installed on the movable seat.

The present invention allows a gentler way to rock multiple cribs, which lowers the risk of hurting infants, and promises simple structure, low cost and ease of use.

### DESCRIPTION OF THE ATTACHED DRAWINGS

FIG. 1 is a structure diagram of the embodiment 2 of the present invention.

FIG. 2 is a structure diagram of the embodiment 1 of the present invention.

FIG. 3 is a structure diagram of the FIG. 2 from another perspective.

FIG. 4 is a structure diagram of the fixed seat in FIG. 2.

FIG. 5 is a structure diagram of the connection mechanism connecting the movable seat and the fixed seat in FIG. 2.

FIG. 6 is the structure diagram of the movable seat in FIG. 5.

FIG. 7 is the structure diagram of the limit block in FIG. 5.

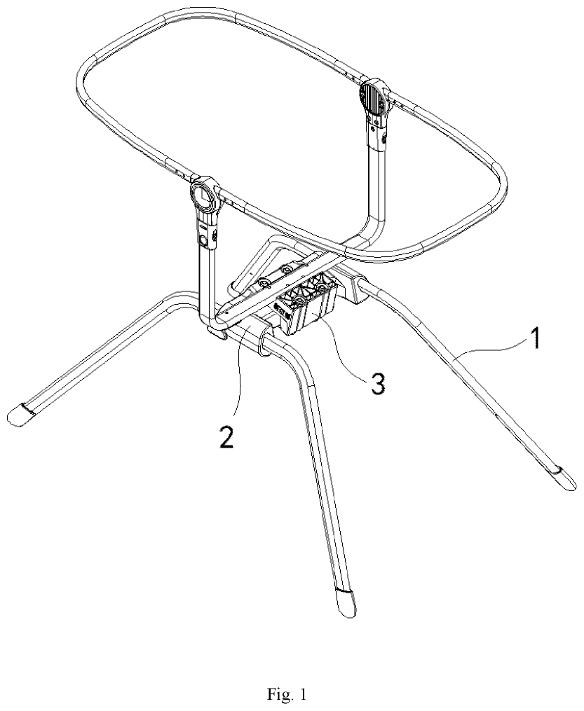

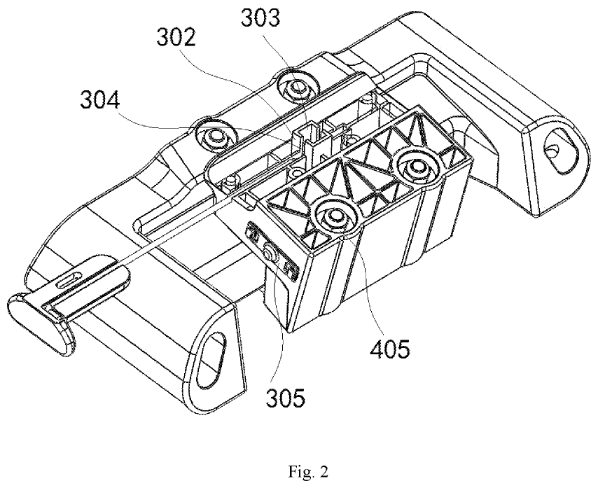

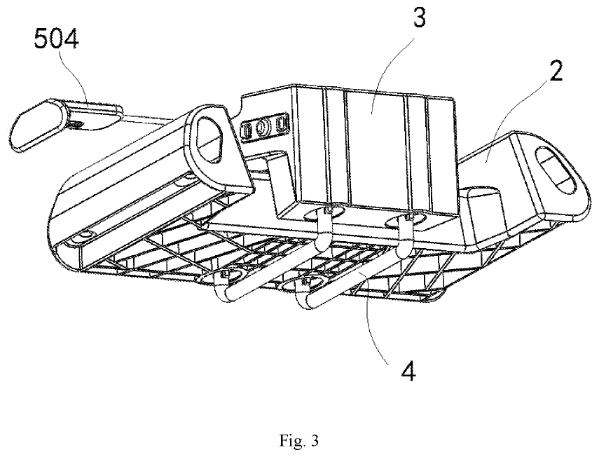

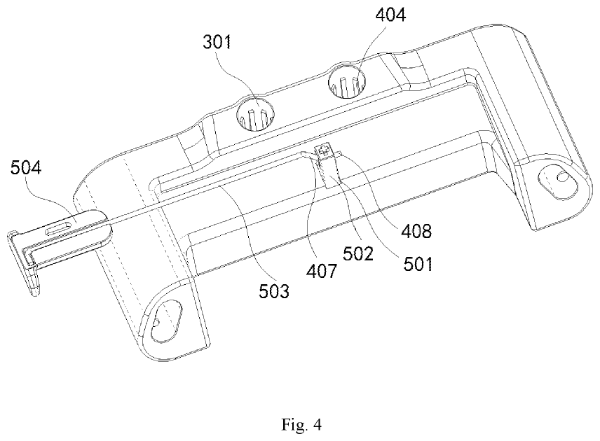

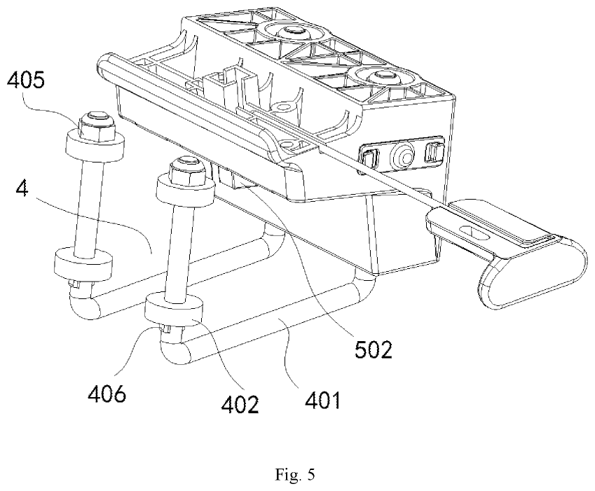

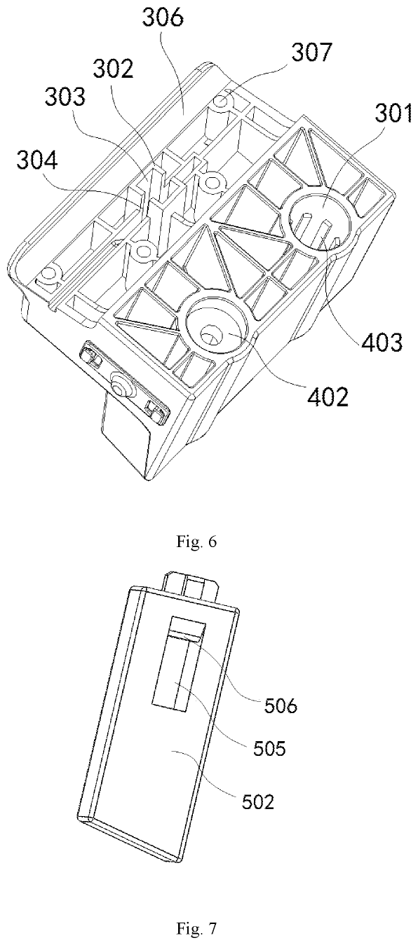

### SPECIFIC IMPLEMENTATIONS

The present invention is described in further detail below in conjunction with its drawings and embodiments.

### Embodiment 1

The rocking mechanism comprises the fixed seats 2 for mounting support legs 1 and the movable seat 3 for mounting the cradle. In this embodiment, the fixed seat 2 comprises two ends and a crossbeam for connecting the two ends, the upper surface of the crossbeam is stepped; the upper end of L-shaped movable seat 3 is connected to the stepped surface of the crossbeam; the support leg 1 is set at the end of the fixed seat 2, and the lower ends of fixed seat 2 and movable seat 3 are provided with the connecting mechanism 4, which includes at least two connecting rods 401 set side by side; the movable seat 3 and the fixed seat 2 are provided with connecting holes 301 connected with the two ends of the connecting rods 401, and the connecting holes 301 are provided with bearings 402 snapped on the connecting rods 401.

In this embodiment, in order to increase the stability of the cradle in the rocking process, two parallel connecting rods 401 are provided; in addition, the upper surface of the movable seat 3 is provided with a slot 306, the bottom surface of the slot 306 is provided with a fixed hole 307. The cradle comprises a cradle frame attached to the movable seat 3; the cradle frame includes a U-shaped support with its opening facing upward and the cradle frame set at the upper end of the U-shaped support, the lower end of the U-shaped support is stuck in the slot 306 and connected to the fixed hole 307 by bolts or other fixed parts for connecting the movable seat 3 and the cradle.

In this embodiment, the two outer walls of the movable seat 3 along the movable direction are provided with anti-collision strips 305. When the cradle frame is rocked, the connecting rod 401 is rotated in the movable seat 3 and the fixed seat 2 under the action of the bearing 402, at which time the end of the connecting rod 401 connected to the movable seat 3 is rotated around the end connected to the fixed seat 2, so as to allow the backward and forward movement of the movable seat 3 on the fixed seat 2. The anti-collision strips 305 at the both sides of the movable seat 3 serve as an effective shock absorber when the movable seat 3 hit the both ends of the fixed seat 2, which reduces the vibration and impact sound to ensure that the baby sleeps peacefully. This kind of mechanism allows a gentler rocking process and eliminates the overturning risk.

In this embodiment, the inner wall of the connection hole 301 is provided with a bearing mount 403, and the bearing 402 is mounted on the bearing mount 403. The bearing mount 403 includes several long bars 404 arranged along the length of the connection hole 301, the said long bars 404 are evenly arranged around the axis of the connection hole 301; the upper and lower ends of the long bars 404 and the inner wall of the both ends of the connection hole 301 come together to provide mounting space for installing the bearing 402; the connecting rod 401 includes two vertical rods and a horizontal rod, the vertical rod is inserted into the connection hole 301, with its upper and lower ends provided with an external thread connected with the limit nut 405 tightened against the upper surface of the bearing 402; and the lower end of the vertical rod is provided with a limit protrusion 406 on its external wall to axially limit the lower bearing 402.

During installation, the lower bearing 402 is pre-installed on the connecting rod 401, and then the connecting rod 401 is inserted into the connecting hole 301 from the bottom up until the lower bearing 402 of the connecting rod 401 rests on the lower surface of the long bar 404; and the limit protrusion 406 on the outer wall of the connecting rod 401 rests on the lower bearing 402, at which time the upper part of the connecting rod 401 protrudes from the upper bearing mount 403 for mounting the upper bearing 402 on the connecting rod 401 from the upper part of the connection hole 301 and limiting it with the limit nut 405 onto the upper end of the long bar 404. By this way to complete the installation of the connecting rod 401 on the movable seat 3 and fixed seat 2, that is, to complete the connection between the fixed seat 2 and movable seat 3.

This embodiment also includes a limiting mechanism structured as follows: a limit slot 501 set on the fixed seat 2 and a limit block 502 set on the movable seat 3 and to be inserted into the limit slot 501, a pull rod 503 connected to the limit block 502 and capable of driving the limit block 502 into or out of the limit slot 501, a toggle 504 for driving the pull rod 503. The pull rod 503 is connected to the limit block 502 at one end and connected to the toggle 504 at the other end. The movable seat 3 is provided with a sliding seat 302, and the sliding seat 302 is provided with a longitudinally extended sliding slot 303, and the limit block 502 is set in the sliding slot 303 and can slide up and down along the inner wall of the sliding slot 303, and the side wall of the sliding seat 302 is provided with a longitudinally extended slot 304 for the pull bar 503 to pass through. The side wall of the limit block 502 is provided with a connection slot 505 for the pull bar 503 to pass through. The upper inner wall of the connection slot 505 is provided with a downwardly curved protrusion 506, the end of the pull rod 503 connected to the limit block 502 is bent downwardly to form an inclined rod section 407 that matches the curved protrusion 506, and the end of the inclined rod section 407 is bent horizontally to form a horizontal rod end 408.

The toggle 504 is mounted on the U-shaped support bar of the cradle frame and the toggle 504 is provided with a waist hole set along the axial direction of the pull bar 503, and the toggle 504 is connected to the U-shaped support bar by a connecting post inserted into the waist hole. When the limit block 502 is located at the horizontal rod end 408 at the end of the pull bar 503, the limit block 502 is at the lowermost part of the sliding seat 302 and the end of the limit block 502 is inserted into the limit slot 501 to limit the movement of the movable seat 3 on the fixed seat 2, at which time the cradle cannot be rocked; when you need to rock the cradle, use the toggle 504 to push the pull bar 503 forward, the inclined rod section 407 on the pull bar 503 applies force to the curved protrusion 506 on the limit block 502, which makes the limit block 502 slide upward along the inner wall of the sliding slot 303 until the lower part of the limit block 502 extends out of the limit slot 501, freeing the movable seat 3 from the limit block 502, and the cradle can be rocked. This simply structured limiting mechanism is easy to use with one hand.

### Embodiment 2

The crib includes the afore-mentioned rocking mechanism, and also the support leg 1 mounted on the fixed seat 2 and the cradle mounted on the movable seat 3.

In short, the above mentioned are only the better embodiments of the invention, and all changes and modifications made in accordance with the scope of the patent application of the invention shall be covered by the patent of the invention.

What is claimed is:

1. A rocking mechanism: wherein a fixed seat (2) for mounting support legs (1) and a movable seat (3) for installing a cradle are provided, a connection mechanism (4) is provided between the fixed seat (2) and the movable seat (3), the connection mechanism (4) includes at least two connection rods (401) set side by side, and the movable seat (3) and the fixed seat (2) are provided with the connection holes (301) to house both ends of the connecting rod (401), and the connection holes (301) are provided with bearings (402) installed on the connecting rod (401).

2. The rocking mechanism according to claim 1, wherein an inner wall of the connection hole (301) is provided with a bearing mount (403), and the bearing (402) is installed on the bearing mount (403).

3. The rocking mechanism according to claim 2: wherein the bearing mount (403) includes several long strips (404) arranged along the length of the connection hole (301), the said long strips (404) are evenly arranged around the axis of the connection hole (301), and upper faces and lower faces of the long strips (404) and the inner walls of the both ends of the connection hole (301) come together to form the mounting space for the bearing (402).

4. The rocking mechanism according to claim 1: wherein the connecting rod (401) includes two vertical rods and one horizontal rod, the vertical rod is inserted into the connecting hole (301) and an upper end and a lower end of the vertical rod are provided with the bearings (402), the upper end of the vertical rod is provided with external threads and has a limit nut (405) that is fastened to the upper surface of the bearings (402), the lower end of the vertical rod is provided with a limit protrusion (406) on an outer wall to axially limit the lower bearing (402).

5. The rocking mechanism, according to claim 1: wherein a limiting mechanism is provided which comprises a limit slot (501) arranged on the fixed seat (2), a limit block (502) arranged on the movable seat (3) and to be inserted into the limit slot (501), a pull rod (503) connected to the limit block (502) to drive the limit block (502) into or out of the limit slot (501), and a toggle (504) for driving the pull rod (503), the pull rod (503) being attached to the limit block (502) at one end and connected to the toggle (504) at the other end.

6. The rocking mechanism according to claim 5: wherein the movable seat (3) is provided with a sliding seat (302), the sliding seat (302) is provided with a longitudinally extended sliding slot (303), the limit block (502) is provided in the sliding slot (303) and can move up and down along the inner wall of the sliding slot (303), a side wall of the sliding seat (302) is provided with a longitudinally extended long slot (304) for the pull rod (503) to pass through.

7. The rocking mechanism according to claim 6: wherein the side wall of the limit block (502) is provided with a connecting slot (505) for the pull rod (503) to pass through, and an upper side of the inner wall of the connecting slot (505) is provided with a downwardly curved protrusion (506), and the end of the pull rod (503) connected to the limit block (502) is bent downwardly to form an inclined rod section (407) that matches the curved protrusion (506), and an end of the inclined rod section (407) is bent horizontally to form a horizontal rod end (408).

8. The rocking mechanism according to claim 1: wherein the movable seat (3) is provided with anti-collision strips (305) on both outer side walls along its moving direction.

9. The rocking mechanism according to claim 1: wherein the movable seat (3) is provided with a slot (306) on its upper surface, and the slot (306) is provided with a fixing hole (307) on its bottom.
